(19) United States
(12) Patent Application Publication
(10) Pub. No.: US 2019/0300441 A1
(43) Pub. Date: Oct. 3, 2019

(54) CERAMIC POWDER, METHOD OF MANUFACTURING CERAMIC POWDER, AND METHOD OF MANUFACTURING CERAMIC OBJECT USING THE CERAMIC POWDER

(71) Applicant: CANON KABUSHIKI KAISHA, Tokyo (JP)

(72) Inventors: Makoto Kubota, Yokohama-shi (JP); Nobuhiro Yasui, Yokohama-shi (JP); Hisato Yabuta, Machida-shi (JP); Kanako Oshima, Tokyo (JP)

(21) Appl. No.: 16/366,421

(22) Filed: Mar. 27, 2019

(30) Foreign Application Priority Data
Apr. 3, 2018 (JP) 2018-071442
Mar. 5, 2019 (JP) 2019-039653

(51) Int. Cl. C04B 35/626; C04B 35/48; C04B 35/14; C04B 35/505; C04B 35/111; B22F 3/105; B28B 1/00

(52) U.S. Cl. CPC C04B 35/626; C04B 35/48; C04B 35/14; B28B 1/001; C04B 35/111; B22F 3/1055; C04B 35/505

(57) ABSTRACT

Ceramic powder to be used for additive manufacturing of a ceramic object by irradiating the powder with laser light includes a first group of particles of a first inorganic compound showing an average particle diameter of not less than 10 μm and not more than 100 μm and a second group of particles of a second inorganic compound having an absorption band at the wavelength of the laser light and showing an average particle diameter smaller than the average particle diameter of the first group of particles. Particles belonging to the second group of particles are arranged on the surfaces of particles belonging to the first group of particles. A high-precision ceramic object can be obtained in a short time by using the ceramic powder.

### BACKGROUND OF THE INVENTION

### Field of the Invention

The present invention relates to a raw powder to be used for manufacturing a ceramic objects by additive manufacturing method, utilizing fusion and solidification of raw powder (including sintering of raw powder) by irradiation of laser light and also to a method for manufacturing a ceramic object using such a raw powder.

### Description of the Related Art

In recent years, there has been a remarkable development in the field of additive manufacturing techniques using laser light (which are also referred to as three-dimensional modeling techniques) and the level of such techniques has also remarkably been raised. Particularly, in terms of metals, manufacturing of elaborate and diverse objects has been made possible by means of selective laser sintering (SLS) and selective laser melting (SLM), which belong to the realm of powder bed fusion (powder lamination). With SLS or SLM, particles of raw metal powder are molten and bound together or sintered to make the powder take a desired profile by means of laser drawing. Compact, high output and low cost near infrared lasers such as YAG lasers and fiber lasers are almost exclusively being employed as lasers for laser drawing operations.

Both SLS and SLM are theoretically applicable to ceramic powders. On the other hand, however, many popular insulating ceramic materials are highly transparent relative to rays of light in wavelength region extending from visible light to near infrared rays. In other words, ceramic powders that are to be used as raw powders practically do not absorb laser light in this wavelength region. For this reason, in instances of additive manufacturing using ceramic materials by using a SLS or SLM device, it is necessary to irradiate laser light of excessively high output power for the purpose of fusing the ceramic material to be processed if compared with the thermal energy required to actually fuse the material. In such instances, additionally, since most of the irradiated laser light that passes through the ceramic particles subsequently spreads, each region of the raw powder that is irradiated with a laser beam and fused inevitably becomes greater than the diameter of the laser beam to make it difficult to clearly draw a boundary line for the object to be produced. Thus, it has hitherto been difficult to realize high-precision ceramic object by means of SLS or SLM.

In an attempt to dissolve the above-identified problem, for example, a technique of additive manufacturing by way of laser light irradiation and the use of a eutectic-based oxide ceramic material were proposed in Physics Procedia 5 (2010) 587-594. More specifically, it is a proposal for lowering the melting point of the powdery material to be used for the manufacturing process by using an Al₂O₃—ZrO₂ eutectic system, thereby reducing the power of the laser beam to be irradiated. The proposed technique provides an advantage of producing ceramic objects showing high mechanical strength because the technique can form fine structures specifically attributable to eutectic systems when the fused material is solidified. While this technique can improve the degree of high precision of the produced ceramic objects to a certain extent, the attained degree of high precision is not satisfactory yet because, among others, the produced ceramic objects show many surface protrusions. Additionally, operations of manufacturing a ceramic object using laser light are time consuming ones because the ceramic materials to be used for such operations show a low heat transfer rate and a low reaction rate if compared with their metal counterparts.

The present invention is made to dissolve this problem. In other words, the present invention provides a raw ceramic powder to be used for obtaining high-precision ceramic objects within a short period of time by means of additive manufacturing using a SLS or SLM device and also a method for obtaining high-precision ceramic objects by using such a raw powder manufacturing method and such a raw powder.

### SUMMARY OF THE INVENTION

In the first aspect of the present invention, there is provided a ceramic powder to be used for additive manufacturing for producing an object by irradiating a raw powder with laser light, the ceramic powder containing a first group of particles of a first inorganic compound showing an average particle diameter of not less than 10 μm and not more than 100 μm and a second group of particles of a second inorganic compound having an absorption band at the wavelength of the irradiated laser light and showing an average particle diameter smaller than the average particle diameter of the first group of particles, the particles belonging to the second group of particles being arranged on the surfaces of the particles belonging to the first group of particles.

In the second aspect of the present invention, there is provided a method of manufacturing a ceramic powder at least comprising: a step of coating the surfaces of the particles belonging to the first group of particles with a solution containing a metal component operating as a precursor of the second group of particles; and a step of heating the particles belonging to the first group of particles and coated with the solution containing the metal component and arranging the particles belonging to the second group of particles on the surfaces of the particles belonging to the first group of particles.

In the third aspect of the present invention, there is also provided a method of manufacturing a ceramic object by using additive manufacturing for producing an object by irradiating a raw powder with laser light comprising:

(i) a step of arranging a ceramic powder as defined above at the laser irradiation section of a laser; and

(ii) a step of selectively irradiating the ceramic powder arranged at the laser irradiation section with laser light to fuse the ceramic powder located at the site irradiated with laser light and subsequently solidifying the fused ceramic powder; and repeating the step (i) and the step (ii).

Further features of the present invention will become apparent from the following description of exemplary embodiments with reference to the attached drawings.

### BRIEF DESCRIPTION OF THE DRAWINGS

FIG. 1 is a schematic cross sectional view of an exemplar device to be used for irradiating a laser beam on a ceramic powder according to the present invention.

FIG. 2 is a schematic cross sectional view of another exemplar device of a type different from the type of the device of FIG. 1 also to be used for irradiating a laser beam on a ceramic powder according to the present invention.

FIGS. 3A and 3B are enlarged schematic partial views of ceramic powders according to the present invention, which are used for comparison. FIG. 3A shows an instance where the particles belonging to the second group of particles are relatively small and FIG. 3B shows an instance where the particles belonging to the second group of particles are relatively large.

FIG. 4 is an enlarged schematic view of a part (a grain) of a ceramic powder according to the present invention that was used in an example and observed through an electronic microscope.

### DESCRIPTION OF THE EMBODIMENTS

Now, a mode of carrying out the present invention will be described below.

The present invention relates to a ceramic powder that can suitably be used as raw powder for obtaining ceramic objects by means of an appropriate additive manufacturing technique using laser light. A ceramic powder according to the present invention contains a first group of particles consisting of inorganic particles of a first inorganic compound that serve as aggregate of ceramic objects and a second group of particles consisting of particles of a second inorganic compound, which is an absorber of laser light, and having an average particle diameter smaller than the average particle diameter of the first group of particles. (Normally a plurality of) particles belonging to the second group of particles are arranged on the surface of each particle that belongs to the first group of particles. As laser light is irradiated onto such a ceramic powder, the second group of particles of the ceramic powder absorb laser light to raise the temperature thereof and then the second group of particles can efficiently convey the obtained heat to the first group of particles of the ceramic powder. Thus, such a ceramic powder can be fused by scanning it with laser light at high speed. Then, as a result, a ceramic powder according to the present invention can be subjected to high-speed manufacturing operations.

A ceramic powder according to the present invention has the following characteristic features.
(1) It can be fused and solidified by irradiation of laser light. Then, as a result, it allows formation of ceramic objects.
(2) It contains a first group of particles consisting of particles of a first inorganic compound and showing an average particle diameter of not less than 10 μm and not more than 100 μm.
(3) It contains a second group of particles consisting of particles of a second inorganic compound and showing an average particle diameter smaller than the average particle diameter of the first group of particles.
(4) The particles belonging to the second group of particles are arranged on the surfaces of the particles belonging to the first group of particles and the second inorganic compound is a laser light absorber having an absorption band that is found on the wavelength of laser light to be irradiated onto the ceramic powder.

Now, each of the above-listed characteristic features will be described in greater detail below.

(Characteristic Feature 1)

A ceramic powder according to the present invention is to be used as a raw material for obtaining ceramic objects and contains a ceramic substance as principal ingredient. As laser light is irradiated onto a ceramic powder according to the present invention, the powder becomes fused at the site of laser irradiation and the fused powder becomes solidified when the laser irradiation is suspended. Note that the expression of “fused and solidified” as used herein refers not only to instances where a ceramic powder according to the present invention is completely liquefied (to become a viscous fluid) and subsequently solidified but also to instances where each of the particles of the powder is softened (at the surface thereof) and the particles are bound together (and hence sintered in other words). This physical property of a ceramic powder according to the present invention becomes advantageously and noticeably apparent particularly when the ceramic powder shows all the characteristic features of (2), (3) and (4).

While there are no particular limitations to lasers that can be used for a ceramic powder according to the present invention, lasers that are being commonly employed for three-dimensional metal manufacturing devices can also be employed for a ceramic powder according to the present invention. For example, compact, high output and relatively low-cost solid-state lasers such as YAG lasers and fiber lasers that are currently being employed for SLS devices and SMS devices can also be employed for a ceramic powder according to the present invention. The oscillation wavelength range of popular solid-state lasers is between 800 nm and 1,200 nm and hence found in the so-called near infrared region (between 0.75 μm and 2.5 μm). The mode of laser oscillation may be either sustained oscillation wave or pulsed oscillation.

For obtaining a high-precision ceramic object, the laser beam irradiation diameter is preferably not less than 10 μm and not more than 200 μm. On the other hand, for obtaining a large object in a short period of time by putting stress on the manufacturing speed, the laser beam irradiation diameter is preferably not less than 200 μm and not more than 2,000 μm.

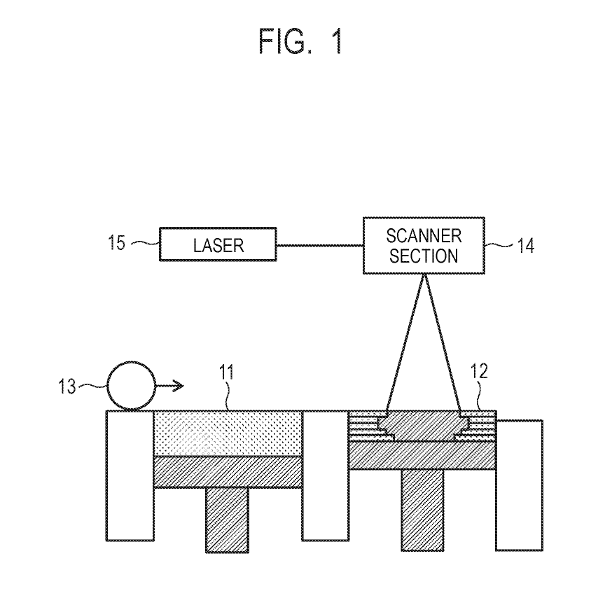

FIG. 1 is a schematic cross-sectional view of an exemplar device to be used for irradiating a laser beam on a ceramic powder according to the present invention. More specifically, FIG. 1 shows the configuration of the device to be used with the selective laser sintering (SLS) method, which is a sort of powder bed fusion. This method is also referred to as powder bed direct manufacturing method. The device illustrated in FIG. 1 comprises a powder cell 11, a manufacturing stage section 12, a recoater section 13, a scanner section 14 and a laser 15. The powder cell 11 is filled with a ceramic powder according to the present invention. The powder cell 11 and the manufacturing stage section 12 are provided with a mechanism for moving them vertically up and down and ceramic powder can be transferred from the powder cell 11 to the manufacturing stage section 12 by means of the recoater 13. Ceramic powder is laid to cover a region in the manufacturing stage section 12 that is larger than the largest horizontal cross section of the ceramic object to be produced.

Subsequently, a laser beam is irradiated onto an area of the ceramic powder that needs to be solidified out of the ceramic powder (of the uppermost layer) in the manufacturing stage section 12 for a laser drawing operation by means of the laser 15 and the scanner section 14. The particles belonging to the second group of particles of the powder in the area irradiated with laser light absorb the irradiated laser light and transform the absorbed energy into heat to consequently fuse the particles belonging to the second group of particles in the area, while the heat is transferred to and fuses the particles belonging to the first group of particles in the area. Thereafter, as the laser beam for irradiating the ceramic powder is positionally shifted to some other area, the fused particles are cooled and become solidified. As a result of the above-described process, an object of a layer is produced. The ceramic powder of the layer that is not fused is left in that layer. Additional ceramic powder is then laid on this layer to produce another layer there and a laser beam is irradiated to a selected area of the laid ceramic powder to fuse and solidify the powder located in the area so as to form an additional object that is integrally combined with the above-described preceding object. A ceramic object having a desired three-dimensional profile can be manufactured by repeating the above-described process.

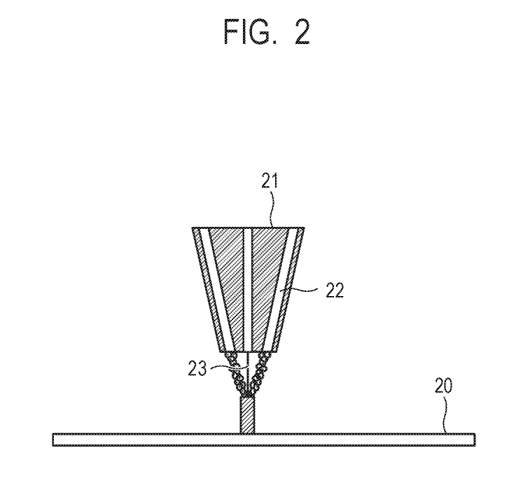

FIG. 2 is a schematic cross-sectional view of another exemplar device that can also be used for irradiating a ceramic powder according to the present invention with a laser beam, which is of a type different from the type of the device of FIG. 1. In other words, FIG. 2 is a drawing that illustrates a manufacturing technique that is referred to as directed energy deposition, which is also referred to as laser cladding manufacturing technique. Referring to FIG. 2, the illustrated device comprises a cladding nozzle 21 that includes a plurality of powder feed holes 22 such that the device operates to eject a ceramic powder according to the present invention from the powder feed holes 22 at a desired flow rate. A laser beam 23 is irradiated to a region of the flow of ceramic powder such that the laser beam 23 is focused at the region so as to additively form a ceramic object in a desired area on a base material 20. Differently stated, with the above-described arrangement, ceramic powder is ejected from the cladding nozzle to the laser light irradiated area (and arranged there) so that the ceramic powder is selectively exposed to the laser beam in that region (where the laser beam is focused). Unlike the powder lamination, this technique provides an advantage that a powder object can be formed on a curved surface.

(Characteristic Feature 2)

A ceramic powder according to the present invention contains a first group of particles showing an average particle diameter of not less than 10 μm and not more than 100 μm. When the average particle diameter of the particles that belong to the first group of particles, which operates as aggregate, is made to be not less than 10 μm and not more than 100 μm, the particles can provide a sufficient degree of fluidity (e.g., 40 seconds/50 g or less) that is required to the operation of transferring powder by means of a recoater or a cladding nozzle in a manufacturing process and the produced object can be made to show a satisfactory level of strength. From the same viewpoint, the average particle diameter of the particles that belong to the first group of particles is preferably not less than 15 μm and not more than 40 μm. Form the viewpoint of fluidity, each of the particles that belong to the first group of particles is preferably spherical, although it may be of an irregular shape or of an anisotropic shape such as a plate-like shape or a needle-like shape. The average particle diameter can be determined from a microscopic image of the powder on the basis of the equivalent circle diameters of the projected images of selected particles. For example, 100 or more particles that belong to the first group of particles may randomly be picked up and, after removing the particles that belong to the second group of particles, adhering to each of the picked-up particles, the equivalent circle diameter of each of the particles may be determined. Then, the average particle diameter can be determined by determining the average of the equivalent circle diameters of the picked-up particles. If the sizes of the particles that belong to the first group of particles vary from particle to particle to a great extent, two or more microscopes whose observation magnifications differ from each other may be combined for use, although the dispersion of the equivalent circle diameters of the picked-up particles is preferably small and the particle diameters (equivalent circle diameters) of not less than 99% of the picked-up particles is preferably not less than 10 μm and not more than 100 μm.

The expression of “powder” as used herein for the purpose of the present invention refers to an aggregation of particles, of which each can be recognized as isolated particle. The expression of “a group of particles” as used herein refers to an aggregation of particles that satisfy one or more predetermined requirements. The first group of particles may not necessarily consist of particles of the same composition so long as they show the above-defined average particle diameter. In other words, the first group of particles may be a mixture of particles of a plurality of different types of compositions that differ from each other.

For the purpose of the present invention, the expression of “an inorganic compound” refers to an oxide, a nitride, an oxynitride, a carbide or a boride that contains one or more elements selected from a group of elements including the elements of the first through fourteenth group on the periodic table, from which hydrogen is excepted, antimony and bismuth. Additionally, for the purpose of the present invention, particles of an inorganic compound may literally be particles of a single inorganic compound or may be particles obtained by combining two or more inorganic compounds. When particles of an inorganic compound are used as principal component of a powder for manufacturing and irradiated with laser light for a fusion and solidification reaction process, a ceramic material can be obtained as reaction product.

The particles of the first inorganic compound that are contained in the first group of particles desirably contain a metal oxide as principal ingredient thereof. A very strong object can be obtained when a ceramic powder according to the present invention contains a metal oxide as principal ingredient. The metal oxide specifically refers to an oxide that contains one or more elements selected from the group of elements formed by excluding boron, carbon, silicon, germanium and the elements of the thirteenth group (nitrogen group) and the fourteenth group (oxygen group) from the above-defined group of elements. While there are many metal oxides, the particles that belong to the first group of particles preferably contain aluminum oxide, silicon dioxide or zirconium oxide as principal ingredient. When aluminum oxide, silicon dioxide or zirconium oxide is selected as principal ingredient and used as aggregate, it is possible to prepare an object that is particularly advantageous in terms of mechanical strength, heat-resistance, electric insulation and environmental protection.

The particles that belong to the first group of particles may be formed by using a single metal oxide alone. However, one or more additional features may advantageously become apparent when such a metal oxide is employed with one or more other substances in combination. For example, preferable combinations of a metal oxide and another substance include a combination of aluminum oxide and zirconium oxide and that of aluminum oxide and a rare earth metal oxide such as gadolinium oxide or yttrium oxide. When the particles that belong to the first group of particles are formed by using such a combination of metal oxides, they produce a eutectic system when they are heated and the melting point falls from the melting point of either of the metal oxides to allow the fusion and solidification reaction process to proceed with ease when they are irradiated with laser light. Additionally, a eutectic structure appears in the solidified object obtained after the fusion of the particles. Then, the object can show a mechanical strength higher than the mechanical strength of an object formed by using a single metal oxide. From this point of view, the particles that belong to the first group of particles desirably contain aluminum oxide and gadolinium oxide. Furthermore, the particles that belong to the first group of particles may contain aluminum nitride and boron nitride in addition to the above-identified metal oxides. As a combination of such substances are employed for the first group of particles, the produced object can become lightweight and show an improved strength if compared with an object formed by using only one or more metal oxides.

(Characteristic Feature 3)

A ceramic powder according to the present invention contains a second group of particles formed by using particles of a second inorganic compound and showing an average particle diameter smaller than the average particle diameter of the first group of particles in addition to the first group of particles formed by using particles of the first inorganic compound. The second inorganic compound has light absorption ability relative to laser beams having wavelengths that are currently being employed for additive manufacturing. The particles that belong to the second group of particles are arranged on the surfaces of the particles that belong to the first group of particles. In other words, while the chemical composition of the particles that belong to the first group of particles of the first inorganic compound and that of the particles that belong to the second group of particles of the second inorganic compound differ from each other, both the particles that belong to the first group of particles and the particles that belong to the second group of particles are principal ingredients of a ceramic powder according to the present invention.

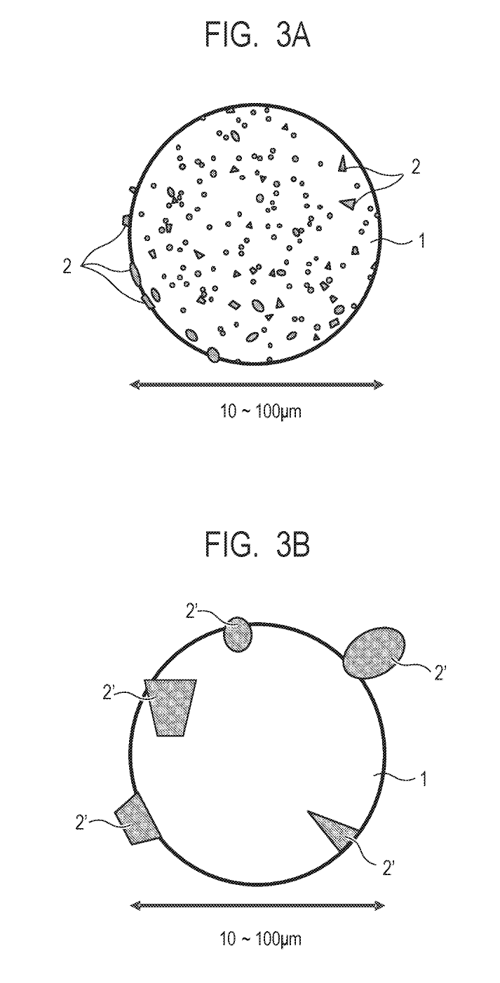

Normally, a plurality of particles belonging to the second group of particles is arranged on the surface of each of the particles belonging to the first group of particles, the average particle diameter of the particles of the second group of particles being smaller than that of the particles of the first group of particles. Each of FIGS. 3A and 3B is an enlarged schematic partial view of a ceramic powder according to the present invention, illustrating a single particle 1 belonging to the first group of particles and a plurality of particles 2 or 2′ belonging to the second group of particles and arranged on the surface of the particle 1. As shown in FIGS. 3A and 3B, a ceramic powder according to the present invention is an aggregation of particles having various profiles as shown FIGS. 3A and 3B.

While each of the particles 1 shown in FIGS. 3A and 3B is substantially spherical, the shapes of the particles 1 are not subject to any particular limitations from the viewpoint of obtaining the advantages of the present invention. A number of particles 2 or 2′ are arranged on the surface of each of the particles 1 and the particles 2 and 2′ belong to the second group of particles. While the average diameter of the particles belonging to the second group of particles, which is strongly related to the effect of expressing the advantages of the present invention, is smaller than the average diameter of the particles belonging to the first group of particles, a small number of particles whose diameters are substantially equal to or larger than the average diameter of the particles belonging to the first group of particles may be included in the particles belonging to the second group of particles in a ceramic powder according to the present invention. In such an instance, a ceramic powder according to the present invention may contain, to a small extent, large particles formed as combinations of smaller particles that are not necessarily found within the scope of the definition that particles belonging to the second group of particle are arranged on the surfaces of the particles of the first group of particles. However, such an instance is permissible for the purpose of the present invention so long as it does not interfere with the effect of expressing the advantages of the present invention. The diameter of a particle can be determined from a microscopic image of the particle on the basis of the equivalent circle diameter of the projected image of the particle. As will be described in detail under Characteristic Feature 4 shown below, the second group of particles has a functional feature of emitting heat as it absorbs laser light. The average diameter of the particles belonging to the second group of particles is preferably not less than 0.05 μm and not more than 2 μm because particles of such an average diameter can very quickly transfer heat to the particle 1.

FIG. 3A shows particles 2 whose average diameter is not less than 0.05 μm and not more than 2 μm and that are arranged on the surface of a particle 1. When the average diameter of the particles 2 is not less than 0.05 μm and laser light is irradiated onto the particles 2, they will provide a remarkably high energy absorption efficiency. When, on the other hand, the average diameter of the particles 2 is not more than 2 μm, the particle 1 and the particles 2 show a large contact area and hence heat will be transferred from the particles 2 to the particle 1 at a high rate. More preferably, the average diameter of the particles 2 is not less than 0.05 μm and less than 1 μm.

FIG. 3B schematically shows a single particle 1 belonging to the first group of particles of a ceramic powder according to the present invention and a plurality of particles 2′ belonging to the second group of particles arranged on the surface of the particle 1. The particles 2′ are relatively larger than the particles 2 shown in FIG. 3A. More specifically, each of the particles 2′ has a particle diameter that is larger than 2 μm (but smaller than 10 μm). FIG. 3A and FIG. 3B differ from each other only in terms of the particle diameters of the particles 2 and the particle diameters of the particles 2′ and both the chemical composition and the crystal structure of the particles 2 are substantially the same as those of the particles 2′. Furthermore, the particle 1 of FIG. 3A and the particle 1 of FIG. 3B are the same in terms of particle diameter, chemical composition and crystal structure and the total mass of the particles 2 adhering to the surface of the particle 1 in FIG. 3A are substantially equal to the total mass of the particles 2′ adhering to the surface of the particle 1 in FIG. 3B. Then, as laser light is irradiated onto both the ceramic powder of FIG. 3A and the ceramic powder of FIG. 3B under the same conditions, the amount of heat generated in the particles 2 in FIG. 3A is substantially equal to the amount of heat generated in the particles 2′ in FIG. 3B.

However, the total contact area between the particle 1 and the particle 2 of the ceramic powder of FIG. 3A is larger than the total contact area between the particle 1 and the particles 2′ of the ceramic powder of FIG. 3B, the heat generated in the particles 2 is transferred quickly to the particle 1 so that the particle 1 starts to be fused quickly and highly efficiently. On the other hand, the total contact area between the particle 1 and the particles 2′ of the ceramic powder of FIG. 3B is relatively small so that the heat generated in the particles 2′ is transferred to the particle 1 relatively slowly. Additionally, the generated heat is spread to the surrounding environment and lost. Then, as a result, the particle 1 of FIG. 3B starts to be fused slowly so that the manufacturing of the ceramic powder of FIG. 3B will proceed only slowly if compared with the ceramic powder of FIG. 3A.

However, it should be noted that the heat transfer rate of the arrangement of FIG. 3A and the heat transfer rate of the arrangement of FIG. 3B are compared above only within the scope of ceramic powder according to the present invention. In other words, the arrangement of FIG. 3B also ensures a manufacturing process that can be completed within a period of time shorter than the time required for a manufacturing process using any known ceramic powder to be completed.

Both the particles 2 in FIG. 3A and the particles 2′ in FIG. 3B provide the advantages of the present invention so long as they are held in contact with the surface of the particle 1 regardless of the strength and the mode of adsorption. Additionally, the particles 2 or the particles 2′ may chemically be bonded to the particle 1 so as to partly penetrate into the inside of the particle 1.

At the time of arranging the particles 2 or the particles 2′ on the surface of the particle 1, they are preferably made to adhere to the particle 1 so as to make them cover the surface of the particle 1 as much as possible. When, for example, the particle 1 is two-dimensionally observed through a microscope, the particles 2 or the particles 2′ are preferably found to be covering the surface of the particle 1 by not less than 10% of the surface area of the particle 1. The surface coverage of the particle 1 by the particles 2 or the particles 2′ is ideally 100% of the surface area of the particle 1.

Not only particles 2 having an average particle diameter of not less than 0.05 μm and not more than 2 μm but also particles 2′ having an average particle diameter larger than 2 μm may be arranged on the surface of the particle 1, although the surface area of the particle 1 covered by particles 2 is preferably larger than the surface area covered by particles 2′.

The mass ratio of the first group of particles to the second group of particles of a ceramic powder according to the present invention is not subject to any particular limitations. However, for example, the mass of the second group of particles is preferably not less than 2% and not more than 20% relative to the mass of the first group of particles because such a mass ratio is advantageous in terms of manufacturing speed, manufacturing accuracy and the strength of the produced object. In the following description, the particles 2 and the particles 2′ will not be discriminated from each other and both of them will simply be referred to as the particles 2.

Note that a ceramic powder according to the present invention may additionally contain particles other than the first group of particles and the second group of particles for the purpose of improving the characteristic features of the ceramic powder itself or the ceramic object formed by using the ceramic powder. Note, however, the mass ratio of the first group of particles and the second group of particles in a ceramic powder according to the present invention is preferably not less than 80 mass %, more preferably not less than 90 mass % from the viewpoint of satisfactorily providing the advantages of the present invention. Additionally, the mass ratio of the first group of particles in a ceramic powder according to the present invention is preferably not less than 70 mass %.

(Characteristic Feature 4)

The second group of particles comprises particles of a second inorganic compound that is a laser light absorber having a laser light absorption wavelength band. Laser light absorbers that can suitably be used for the second group of particles are required to efficiently absorb laser light to become hot and transfer heat to the compositions that are located around the absorber particles and do not have any laser beam absorption ability. Then, as a result, a laser light irradiated area is locally heated to produce a clear boundary zone between the laser light irradiated area and the laser light non-irradiated area that surround the laser light irradiated area so as to allow realization of a high-precision object.

The particles of the second inorganic compound contained in the second group of particles is preferably characterized by giving rise to a compositional change as a result of irradiation of laser light and making the laser light absorptivity of the object produced by the laser light irradiation on the ceramic powder containing the second group of particles as observed after the solidification of the object lower than the laser light absorptivity of the ceramic powder as observed before the irradiation of laser light. When the laser light absorptivity of the laser light irradiated area of the ceramic powder after the irradiation of laser light and the completion of the manufacturing process is lowered, the quality of the shaped region is prevented from being altered when laser light is irradiated onto adjacently located regions.

Preferably, the particles of the second inorganic compound contained in the second group of particles comprise a metal oxide and the change in the laser light absorptivity is attributable to a change in the valence of the metal element of the metal oxide. A change in the laser light absorptivity that is attributable to a valence change does not accompany any volume change. To the contrary, when the laser light absorptivity is changed as a result of discharge of a volatile substance from particles that are laser light absorbers, the change in the laser light absorptivity is accompanied by a remarkable volume change. Examples of metal oxides whose valences change and whose laser light absorptivities fall to nil as a result of laser light irradiation include oxides of Ti, V, Cr, Mn, Fe, Co, Ni, Cu, Zn, Zr, Nb, Mo, Hf, Ta, W, In, Sn, Bi, Ce, Pr, Sm, Eu, Tb and Yb. A plurality of metal oxides selected from the above-listed ones may be combined to form the second group of particles.

Lasers to be used for manufacturing a ceramic object for the purpose of the present invention are preferably lasers using a wavelength around 1,000 nm such as Nd:YAG lasers and Yb fiber lasers from the viewpoint of commercial availability and controllability of irradiation energy. Preferable materials that show a high laser light absorptivity in the above-identified wavelength range and give rise to a fall of absorptivity include terbium oxide (Tb₄O₇) containing tetravalent terbium and praseodymium oxide (Pr₆O₁₁) containing tetravalent praseodymium. When the second group of particles of a ceramic powder according to the present invention contains as principal ingredient thereof terbium oxide containing tetravalent terbium or praseodymium oxide containing tetravalent praseodymium, the second group of particles effectively generate heat by absorbing laser light but subsequently loses its laser light absorption ability as a result of a fall of the valence of the metal element thereof.

The valence of terbium of terbium oxide can take any of the various values that are specific to it. Similarly, the valence of praseodymium of praseodymium oxide can take any of the various values that are specific to it For instance, terbium oxide may typically exist in the form of Tb₄O₇ or in the form of Tb₂O₃. While the former terbium oxide is expressed as Tb₄O₇ for its molecular formula, the ratio of the number of metal atoms to the number of oxygen atoms is not rigorously limited to such one but only close to 4:7. More specifically, substantially equal numbers of Tb⁴⁺ and Tb³⁺ exist, whereas the metal atoms of the latter terbium oxide, or Tb₂O₃, exist only in the form of trivalent terbium, or Tb³⁺.

Tb₄O₇ shows a high infrared absorptivity at and near the wavelength of 1,000 nm and its infrared absorptivity sometimes exceeds 60% and gets to 70%. On the other hand, as the content ratio of Tb⁴⁺ falls in the given terbium oxide, its infrared absorptivity also falls and the infrared absorptivity of Tb₂O₃, in which only Tb³⁺ exists, will be as low as about 7%. Therefore the use of absorber particles of terbium oxide (Tb₄O₇) that contain tetravalent terbium is suitable as principal ingredient of the inorganic compound particles B to be used to realize a ceramic powder according to the present invention. Similarly, the use of absorber particles of praseodymium oxide (Pr₆O₁₁) that contain tetravalent praseodymium is suitable as principal ingredient of the inorganic compound particles B to be used to realize a ceramic powder according to the present invention.

A technique of X-ray absorption fine structure (XAFS) analysis can suitably be used to look into the valence or valences of the metal atoms of an inorganic metal oxide to be used for the purpose of the present invention. The valence of a metal atom can be detected on the basis of the profile of the rising energy from an absorption edge by utilizing the phenomenon that the rising energy from an absorption edge varies as a function of the valence of the metal that is being looked into.

(Manufacturing Method)

While the method to be used for manufacturing a ceramic powder according to the present invention and having the above-described characteristic features is not subject to any particular limitations, a preferable manufacturing method will be described below. A method of manufacturing a ceramic powder according to the present invention has the following characteristic features.
(5) The method has a step of coating the surfaces of the particles belonging to the first group of particles with a metal ingredient-containing solution that operates as precursor of particles belonging to the second group of particles.
(6) The method has a step of heating the particles belonging to the first group of particles that are coated with the metal ingredient-containing solution in the above step to arrange the particles belonging to the second group of particles on the surfaces of the particles belonging to the first group of particles.

(Characteristic Feature 5)

A suitable method of manufacturing a ceramic powder according to the present invention has a step of coating the surfaces of the particles 1 belonging to the first group of particles with a metal ingredient-containing solution that operates as precursor of particles 2 belonging to the second group of particles.

Materials that can suitably be used for the particles 1 are described above and, for example, commercially available metal oxide particles can be used for the purpose of the present invention. A process of surface modification may be executed on the particles 1 for the purpose of improving the wettability and the stickiness of the surfaces of the particles 1. Techniques that can be used for such surface modification typically include irradiation of energy rays such as ultraviolet rays and application of a surface modifying agent such as a silane coupling agent or a sulfonic acid derivative. Alternatively, the particles 1 may be immersed in a surface modifying agent such as a silane coupling agent or a sulfonic acid derivative.

The metal oxide-containing solution that operates as precursor of particles 2 refers to a solution or a dispersion having a composition that can produce particles 2 when heated. Examples of such compositions include hydrolysable or pyrolyzable organic metal compounds. More specific examples include metal alkoxides, salts of organic acids and metal complexes such as β-diketone complexes of the above-listed metals. Other examples of metal complexes that can be used for the purpose of the present invention include amine complexes. Examples of β-diketones include acetylacetone (=2,4-pentanedione), heptafluorobutanoyl pivaloylmethane, dipivaloylmethane, trifluoroacetylacetone and benzoyl axetone. Since oxygen elements coordinate to a metal atom in β-diketone complexes, such complexes can be regarded as a form metal alkoxide.

When, for example, terbium oxide is employed as principal ingredient of particles 2, a technique of causing the precursor, which is a metal component-containing solution, to contain a terbium alkoxide can be employed. Examples of terbium alkoxides include terbium-n-butoxide, terbium-t-butoxide, terbium-methoxypropoxide, terbium-methoxyethoxide, terbium-2,4-pentanedionate and terbium-2,2,6,6-tetramethyl-3,5-heptanedionate.

Examples of praseodymium alkoxides include praseodymium-n-butoxide, praseodymium-t-butoxide, praseodymium-methoxypropoxide, praseodymium-hexafluoropentanedionate, praseodymium-2,4-pentanedionate, praseodymium-2,2,6,6-tetramethyl-3,5-heptanedionate and praseodymium(III)-6,6,7,7,8,8,8-heptafluoro-2,2-dimethyl-3,5-octanedionate. The above description equally applies to alkoxides of other metal elements.

Metal alkoxide and solution thereof to be used for the purpose of the present invention may be commercially available ones. Alternatively, they can synthetically be prepared by using the method defined in the claims of Japanese Patent Application Laid-Open No. H09-157272 and described in paragraph [0003]. A composition that contains the metal ingredient or ingredients as described above can be dissolved or dispersed into an appropriate solvent to obtain a metal-containing solution to be used for the purpose of the present invention. The solvent to be used can appropriately be selected from known various solvents by taking the dispersability and the applicability thereof into consideration.

Examples of solvents that can be used to prepare a metal-containing solution for the purpose of the present invention include alcohols such as methanol, ethanol, n-butanol, n-propanol and isopropanol, ethers such as tetrahydrofuran and 1,4-dioxane, cellosolves such as methyl cellosolve and ethyl cellosolve, amides such as N,N-dimethylformamide, N,N-dimethylacetamide and N-methylpirrolidone, and nitriles such as acetonitrile. When a metal alkoxide is employed as metal component, the use of an alcoholic solvent is preferable.

While the amount of the solvent to be used to prepare a metal ingredient-containing solution is not subject to any particular limitations, the solvent can suitably be used to coat the surfaces of the particles 1 when the amount of the solvent is so adjusted as to make the metallic solid concentration found between 5 mass % and 20 mass %.

The technique to be used to coat the surfaces of the particles 1 is not subject to any particular limitations. For example, the particles 1 may be immersed in the solution or the solution may be poured onto the particles 1. Alternatively, the solution may be sprayed onto the particles 1 by means of a sprayer.

(Characteristic Feature 6)

After the above-described step, a step of producing particles 2 on the surfaces of the particles 1 by simultaneously heating both the particles 1 and the metal ingredient-containing solution adhering to the surfaces of the particles 1 is executed.

As a result of the heating step, the solvent of the metal ingredient-containing solution is driven away and additionally the metal ingredient is oxidized and turned into particles. Thus, particles 2 become deposited on the surfaces of the particles 1. When the precursor is compositionally hydrolysable, a hydrolysis reaction proceeds to bind oxygen atoms to the metal atoms to consequently produce fine particles of metal oxide having a particle diameter of less than 1 μm. Additionally, since particles 2 are produced as a result of a chemical reaction, they are strongly bonded to the particles 1 as aggregate and held in contact with particles 1 with a large overall contact area. Thus, when they are irradiated with laser light, the heat generated in the particles 2 will quickly be conveyed to the particles 1.

An optimum heating temperature needs to appropriately be selected depending on the types of the materials to be heated. A stepwise heating process may preferably be employed. For example, the solvent may typically be heated to a temperature level somewhere between about 150° C. and about 300° C. for the purpose of volatilization and subsequently the particles 2 may be heated to a temperature level somewhere between about 550° C. and about 700° C.

The heating means to be used for the above-described heating operation is not subject to any particular limitations and a drier, a hot plate, an electric furnace, an atmosphere furnace or the like may appropriately be employed. After the heating process, a process of additionally crushing the obtained powder into fine particles and a process of producing particles of a uniform size by sieving the crushed powder may be executed.

(How to Use Powder for Ceramic Manufacturing)

The above-described method of manufacturing a ceramic object by using a powder for manufacturing a ceramic object according to the present invention as starting material and irradiating the starting material with laser light is characterized by comprising the following steps.
(7) The method comprises step (i) of arranging the powder for manufacturing a ceramic object at the laser irradiation section.
(8) The method comprises step (ii) of sintering or fusing the powder for manufacturing a ceramic object arranged at the laser irradiation section by selectively irradiating it with a laser beam and (if the powder is fused) substantially solidifying it.
(9) The method comprises step (iii) of manufacturing a ceramic object by repeating step (i) and step (ii).

(Characteristic Feature 7)

The technique to be used to arrange a powder for manufacturing a ceramic object according to the present invention at the laser irradiation section is already described above under (characteristic feature 1). For example, when a device as illustrated in FIG. 1 is employed, a powder for manufacturing a ceramic object according to the present invention that is filled in a powder cell can be arranged at the manufacturing stage section 12 by means of the recoater section 13. Alternatively, as described above under (characteristic feature 1) by referring to FIG. 2, an object can be formed on a curved base by ejecting a powder for manufacturing a ceramic object to a predetermined site and irradiating the site with laser light.

(Characteristic Feature 8)

The technique that can be used to select a laser for fusing a powder for manufacturing a ceramic object and subsequently solidifying it is described above under (characteristic feature 1). As described earlier, sintering can be used as a mode of fusing and subsequently solidifying operation for the purpose of the present invention. More rigorously, sintering refers to an operation of binding powder particles in a solid phase to make them grow to larger particles (without fusing the powder), whereas fusing refers to an operation to bring powder particles in a solid phase into a liquid phase and includes an intermediary condition where powder particles in a solid phase and powder particles in a liquid phase coexist. Preferably, prior to step (ii), the powder for manufacturing a ceramic object arranged at the laser irradiation section is laid flat before it is irradiated with laser light in order to obtain a highly dense object.

(Characteristic Feature 9)

A patterned layer of a ceramic object is obtained by executing step (i) and step (ii) once. Then, additional ceramic powder is laid on the produced object and step (i) and step (ii) are executed with a different pattern. A ceramic object showing a desired three-dimensional profile can be manufactured by repeating step (i) and step (ii), using different patterns.

After the manufacturing operation, the produced object may be subjected to a heating process for the purpose of improving the density and the strength of the object and re-oxidizing the object. During this process, an organic compound or an inorganic compound may be applied to the object as glaze so as to make the object impregnated with the compound. The heating means to be used for this heating process is not subject to any particular limitations. Differently stated, an appropriate heating technique may be selected from resistor heating, induction heating, heating using an infrared lamp, laser heating, electron beam heating and other heating techniques.

### EXAMPLES

Now, a ceramic powder, a ceramic powder manufacturing method and a method of using a ceramic powder according to the present invention will be described in greater detail by way of examples. Note, however, that the examples as described herein do not limit the scope of the present invention by any means.

### Example 1

In this example, a ceramic powder according to the present invention was prepared by way of the following sequence.

A mixture of Al₂O₃ powder (purity not less than 99%, average particle diameter: 20 μm) and C₂dO₃ powder (purity not less than 99%, average particle diameter: 20 μm), which are commercially available industrial goods, was prepared to make the mixture show a mass ratio of 1:1, which powder mixture was then employed as first group of particles.

A metal alkoxide solution of terbium, which is a hydrolysable organic metal compound, was prepared as metal ingredient-containing solution that operates as precursor of particles for forming the second group of particles. More specifically, terbium-2,4-pentadionate, which is a commercially popularly available reagent, was dissolved into 1-methoxy-2-propanol, which operated as solvent so as to make the concentration thereof be equal to 10 mass % in terms of the organic metal oxide (Tb₄O₇).

The first group of particles was taken by 97 g and put into a high purity alumina-made container and the metal ingredient-containing solution was added thereto by 25 g. Then, the solution was agitated well.

Then, the container was put into an electric furnace, which was filled with the atmosphere, and a heating process was conducted by executing a program of maintaining the maximum temperature of 600° C. for 3 hours. After the electric furnace was cooled to the room temperature, the content was taken out from the alumina container and then subjected to a crushing process to obtain a ceramic powder according to the present invention.

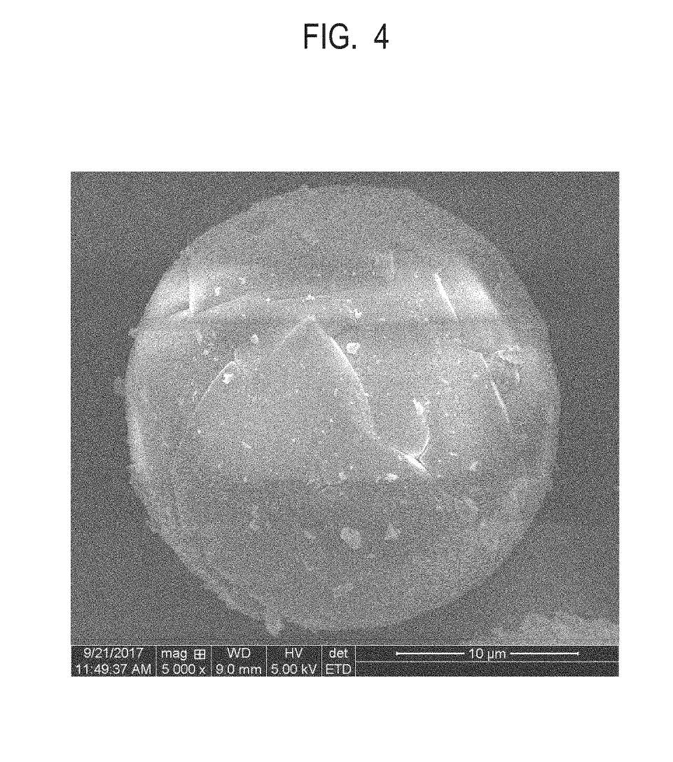

FIG. 4 shows an enlarged view of a specimen taken from the manufactured ceramic powder and observed through an electronic microscope. More specifically, FIG. 4 shows an image of the specimen obtained with a magnification of 5,000 so as to make the typical structure of the ceramic powder of Example 1 clearly visible. Other specimens taken from the same manufactured powder also provided similar microscopic images and showed similar structures. The spherical particle having a diameter of about 20 μm that took a major part of the view range of the microscope was identified as a particle 1 of aluminum oxide that belonged to the first group of particles as a result of an SEM-EDX analysis and an X-ray diffraction measurement. The fine particles adhering to the surface of the particle 1 was identified as particles of terbium oxide (Tb₄O₇) that belonged to the second group of particles also as a result of an SEM-EDX analysis and an X-ray diffraction measurement. The average particle diameter of the second group of particles determined by processing the observed image was 0.3 μm at most. Since the observed second group of particles included micro particles that could not be recognized by processing the image, the actual average diameter of the second group of particles might have been even smaller. As a result of calculations executed by using the observed image, it was determined that each of the particles of the first group of particles was covered by particles of the second group by about 14% of its entire surface area.

Although not seen in the observed image in FIG. 4, an aggregation of particles in which particle 1 was a particle of gadolinium oxide also existed in the vicinity of the above particle 1 and fine particles 2 also adhered to the particle 1 of gadolinium oxide.

The ceramic powder of Example 1 was dissolved in dilute sulfuric acid so as to make it warm and the composition was analyzed by means of ICP-atomic emission spectrophotometry to find that the mass ratio of Al₂O₃, Gd₂O₃ and Tb₄O₇ was 46.6:50.3:2.46. The mass content ratio of all the remaining ingredients was less than 0.1 mass % relative to all the ceramic powder. Al₂O₃ and Gd₂O₃ belonged to the first group of particles and, when combined, took 96.9 mass % of the mass of all the ceramic powder.

### Example 2 and Example 3

The ceramic powders of these examples were manufactured as in Example 1 except that the starting materials as listed in Tale 1 were employed with different mixing ratios, which mixing ratios are also shown in Table 1, for these examples.

ZrO₂ powder (purity not less than 99%, average particle diameter: 15 μm) that is commercially available as industrial good was employed as zirconium oxide belonging to the first group of particles. Praseodymium-2,4-pentanedionate that is commercially available as general reagent was employed as metal alkoxide of praseodymium.

The ratio of the amount of the metal ingredient-containing solution, which operated as the precursor of the second group of particles, relative to the amount of the first group of particles was appropriately differentiated from example to example.

### Example 4 and Example 5

The ceramic powders of these examples were manufactured as in Examples 1 through 3 except that the starting materials as listed in Tale 1 were employed with different mixing ratios, which mixing ratios are also shown in Table 1, for these examples.

Note, however, that not particles derived from a metal alkoxide but Tb₄O₇ powder (average particle diameter: 3 μm) and Pr₆O₁₁ powder (average particle diameter: 4 μm), both of which are commercially available, were employed for the second group of particles.

### Comparative Examples 1 Through 3

Ceramic powders of these comparative examples were manufactured as in Example 1, using the mixing ratios as shown in Table 1. Note, however, that the ceramic powder of Comparative Example 1 was formed only by using the first group of particles and no second group of particles were used for this comparative example. The powder for manufacturing a ceramic object of Comparative Example 2 was formed by mixing powder of an average particle diameter of 40 μm obtained by calcining commercially available Tb₄O₇ power at 700° C. in an electric furnace and Pr₆O₁₁ powder (average particle diameter: 50 μm) without using any metal ingredient-containing solution for operating as precursor of the second group of particles.

TABLE 1

| | Al₂O₃ | | ZrO₂ | | Gd₂O₃ | | Tb₄O₇ | | Pr₆O₁₁ | | |
|---|---|---|---|---|---|---|---|---|---|---|---|
| | | Average | | Average | | Average | | Average | | Average | Coverage of |
| | Weight | particle | Weight | particle | Weight | particle | Weight | particle | Weight | particle | 2^{nd} group of |
| | ratio | dia. | ratio | dia. | ratio | dia. | ratio | dia. | ratio | dia. | particles |
| | (mass %) | (μm) | (mass %) | (μm) | (mass %) | (μm) | (mass %) | (μm) | (mass %) | (μm) | (area %) |
| Example 1 | 46.6 | 20 | — | — | 50.3 | 20 | 2.46 | 0.3 | — | — | 14 |
| Example 2 | 35.2 | 20 | 25.5 | 15 | 35.5 | 20 | 3.40 | 0.3 | — | — | 20 |
| Example 3 | 45.9 | 20 | — | — | 50.1 | 20 | — | — | 3.15 | 0.5 | 18 |
| Example 4 | 36.3 | 20 | 25.7 | — | 34.8 | 20 | 2.75 | 3 | — | — | 24 |
| Example 5 | 46.1 | 20 | — | — | 49.9 | 20 | — | — | 3.10 | 4 | 31 |
| Comp. Ex. 1 | 46.8 | 20 | — | — | 52.9 | 20 | — | — | — | — | — |
| Comp. Ex. 2 | 46.5 | 20 | — | — | 50.5 | 20 | 2.80 | 40 | — | — | 2 |
| Comp. Ex. 3 | 45.6 | 20 | — | — | 51.1 | 20 | — | — | 3.05 | 50 | 1 |

(Use of Powder for Manufacturing a Ceramic Object)

For the purpose of clarifying the differences among the ceramic powders of the examples and the comparative examples in terms of manufacturing speed, the powder of each of the examples and the comparative examples was laid down on a flat alumina base member having a sufficiently large surface area to a thickness of about 50 μm and the surface of the layer was irradiated with laser light. The size of the focal spot of the laser light was made to be equal to 100 μm and the output power was made to be equal to 30 W. The laser light was so irradiated as to scan for a length of 4.5 mm and draw two lines at a pitch of 50 μm. Four scanning speeds of 100 mm/sec, 250 mm/sec, 500 mm/sec and 1,000 mm/sec were adopted and the scanning operations were conducted under the above-described respective scanning conditions to compare the fused states of the powders under these different conditions.

An operation of microscopic observation was executed for each of the examples and the comparative examples to see if the powder arranged at the laser light irradiation section was solidified after the laser light irradiation and a ceramic object was formed there or not. Table 2 shows the obtained results.

In each of Examples 1, 2 and 3, a ceramic object was obtained with each of the above-listed laser beam scanning speeds as a result of laser beam irradiation. Particularly, when the scanning speeds of 250 mm/sec, 500 mm/sec or 1,000 mm/sec was used, the boundary separating the laser light irradiated area and the laser light non-irradiated area showed a narrow width of not more than 15 μm and hence a high manufacturing accuracy level was achieved. A rating of “a” was given to the ceramic objects that showed such a high manufacturing accuracy level as shown in Table 2. When, on the other hand, the scanning speed of 100 mm/sec was used, the boundary line of the ceramic object showed fluctuations and the boundary showed a relatively large width of about 40 μm. A rating of “b” was given to such ceramic objects that may be satisfactory but are accompanied by a slight problem in terms of manufacturing accuracy as shown in Table 2.

Thus, a powder for manufacturing a ceramic object that meets the requirements of the present invention can satisfactorily be used to manufacture ceramic objects if a high laser beam scanning speed is adopted so that the present invention can reduce the time required to produce any desired object to less than a half of the time required by any comparable existing technique.

A ceramic object was obtained by using the ceramic powder of Comparative Example 1 when laser light was irradiated onto the ceramic powder with a scanning speed of 100 mm/sec but the boundary separating the laser light irradiated area and the laser light non-irradiated area was not clear and part of the ceramic powder was found unfused. Furthermore, when a laser beam scanning speed of 250 mm/sec or higher speed was used, fusion of the ceramic powder did not proceed and hence the powder was not turned into an object at all. A rating of “c” was given to the instances where a ceramic object could not be obtained with a satisfactory level of accuracy as shown in Table 2.

When a laser beam was irradiated onto the ceramic powder of each of Comparative Example 2 and Comparative Example 3, an object with an excellent degree of manufacturing accuracy was obtained with a laser beam scanning speed of 100 mm/sec or 250 mm/sec. However, when a laser beam scanning speed of 500 mm/sec was used, the produced object contained parts that remained powdery to a small extent. When a laser beam scanning speed of 1,000 mm/sec was used, fusion did not proceed at all and the powder was not turned into an object at all.

TABLE 2

| | laser beam scanning speed | | | |
|---|---|---|---|---|
| | 100 mm/sec | 250 mm/sec | 500 mm/sec | 1000 mm/sec |
| Example 1 | b | a | a | a |
| Example 2 | b | a | a | a |
| Example 3 | b | a | a | a |
| Example 4 | a | a | a | b |
| Example 5 | a | a | a | b |
| Comp Ex 1 | b | c | c | c |
| Comp Ex 2 | b | b | c | c |
| Comp Ex 3 | b | b | c | c |

### Example 4

In this example, a desired three-dimensional ceramic object was obtained in each of the instances where the powders for ceramic object of Examples 1 through 3 were put into respective SLS devices as shown in FIG. 1 and respectively scanned by laser beams at a scanning speed of 1,000 mm/sec and the manufacturing step was repeated for several times according to shape of the desired three-dimensional ceramic object.

### INDUSTRIAL APPLICABILITY

Precision ceramic objects can be obtained by three-dimensional manufacturing, using a powder for manufacturing a ceramic object according to the present invention. Thus, the present invention can find applications in the field of ceramic parts that are required to show a complex profile.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-071442, filed Apr. 3, 2018, and Japanese Patent Application No. 2019-039653, filed Mar. 5, 2019, which are hereby incorporated by reference herein in their entirety.

What is claimed is:

1. A ceramic powder to be used for additive manufacturing for producing an object by irradiating a raw powder with laser light, the ceramic powder containing:
a first group of particles of a first inorganic compound showing an average particle diameter of not less than 10 μm and not more than 100 μm and a second group of particles of a second inorganic compound having an absorption band at the wavelength of the laser light and showing an average particle diameter smaller than the average particle diameter of the first group of particles;
the particles belonging to the second group of particles being arranged on the surfaces of the particles belonging to the first group of particles.

2. The ceramic powder according to claim 1, wherein
the average particle diameter of the second group of particles is not less than 0.05 μm and not more than 2 μm.

3. The ceramic powder according to claim 1, wherein
the average particle diameter of the second group of particles is not less than 0.05 μm and less than 1 μm.

4. The ceramic powder according to claim 1, wherein
the second group of particles is fused and solidified by the laser light irradiation to give rise to a compositional change and a fall of the laser light absorptivity thereof.

5. The ceramic powder according to claim 4, wherein
the second group of particles comprises a metal oxide and the fall of the laser absorptivity is caused by a change in the valence of the metal element of the metal oxide.

6. The ceramic powder according to claim 5, wherein
the second group of particles contains as principal ingredient thereof either terbium oxide that includes tetravalent terbium or praseodymium oxide that includes tetravalent praseodymium.

7. The ceramic powder according to claim 1, wherein
the first group of particles contains as principal ingredient thereof either aluminum oxide or zirconium oxide.

8. A method of manufacturing a ceramic powder as defined in claim 1 comprising at least:
a step of coating the surfaces of the particles belonging to the first group of particles with a metal ingredient-containing solution and operating as a precursor of the second group of particles; and
a step of heating the particles belonging to the first group of particles and coated with the metal ingredient-containing solution and arranging the particles belonging to the second group of particles on the surfaces of the particles belonging to the first group of particles.

9. A method of manufacturing a ceramic object by using additive manufacturing for producing an object by irradiating a raw powder with laser light, the method comprising:
(i) a step of arranging a ceramic powder as defined in claim 1 at a laser irradiation section; and
(ii) a step of selectively irradiating the ceramic powder arranged at the laser irradiation section with laser light to fuse the ceramic powder located at the site irradiated with laser light and subsequently solidifying the fused ceramic powder; and
repeating the step (i) and the step (ii).

10. The method according to claim 9, wherein
the steps (i) and (ii) include irradiating the ceramic powder with laser light after laying down the ceramic powder at the laser irradiation section.

11. The method according to claim 9, wherein
the steps (i) and (ii) include ejecting the ceramic powder to a predetermined portion and irradiating the predetermined portion with laser light.
